(19) United States
(12) Patent Application Publication
(10) Pub. No.: US 2011/0115588 A1
(43) Pub. Date: May 19, 2011

(54) Magnetic Attachment of Detector Modules enabling front side removal

(75) Inventor: Joel Kindem, San Diego, CA (US)

(73) Assignee: Digirad Corporation, Poway, CA (US)

(21) Appl. No.: 12/948,266

(22) Filed: Nov. 17, 2010

Related U.S. Application Data
(60) Provisional application No. 61/262,097, filed on Nov. 17, 2009.

(51) Int. Cl. H01F 7/02

(52) U.S. Cl. 335/285

(57) ABSTRACT

Magnetic attachment for a multisided buttable module.

This application claims priority from provisional application No. 61/262,097, filed Nov. 17, 2009, the entire contents of which are herewith incorporated by reference.

### BACKGROUND

Four sided buttable image detection modules are often used in applications where image sensing needs to be carried out using a large image sensor array that has little or no dead areas between the image sensor parts.

A semiconductor camera using a 4 sided buttable image sensor is described in US Patent publication number 2001-0025928.

### SUMMARY

An embodiment describes magnetic fastening used in a 4-side buttable module. An embodiment describes a controlled pressure interface with accurate mechanical registration where there is no access or difficult access from the back side, and/or when blind fastening is required.

### BRIEF DESCRIPTION OF THE DRAWINGS

in the drawings:

FIG. 1 shows a plan view of the assembly.

### DETAILED DESCRIPTION

Multi-sided buttable modules have been used in image acquisition, especially with a gamma camera. The module is placed downstream of a collimator, in order to obtain high energy photons from the main body of the gamma camera.

Conventionally, a standard mechanical fastener such as a screw, spring snap, tape, or other has attached to the back of the module, holding said module in place against a registration point.

The inventors recognize a problem with this solution, however, is that a module requires access to the backside to remove it. Also, fastening and defastening may require either applied force such as a spring snap, turning of a screw, placing tape, or other force. The force can damage the image module.

The present application describes a magnetic attachment device which can be used, for example, in a multisided buttable module such as an image sensor module. The magnetic attachment may address the problems noted above of fastening these devices. The magnetic attachment provides a blind fastening where access to the backside of the module is not required for removal. In one embodiment, no positive force is required to install the module.

This compares with items such as a spring snap, such as been used by the prior art, which requires positive force to install the item.

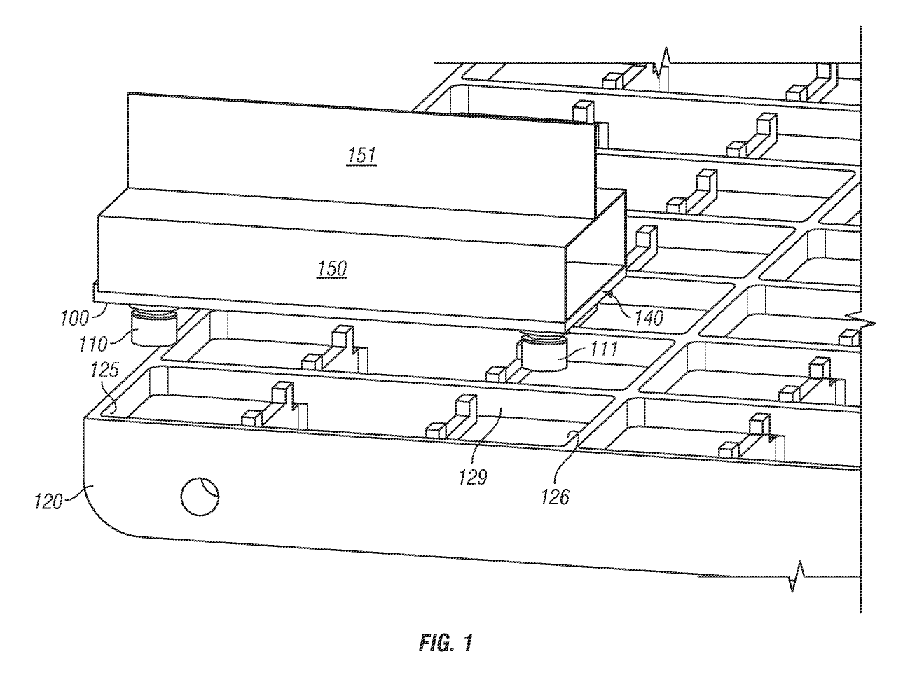

FIG. 1 shows the basic elements of an embodiment. The module 100 is a multisided buttable image acquisition module. The module 100 is attached to a number of magnets 110, 111 on four perimeter edges. (Two of the magnets on the backside are not shown in FIG. 1). The magnets are attached at edges of the module in this embodiment. The module itself is attached to a mechanical support 120 at registration points on the mechanical support. A top surface of the mechanical support includes chamber surfaces such as 125, 126 that hold and position the magnets.

In one embodiment, the magnets may be substantially cylindrical and hence circular in outer cross-section. A corresponding circular chamber surface 125, 126 can position the magnets to place them in a precise location.

A ferromagnetic element 140 is formed of tin plated steel which is soldered to the module 100.

The magnets 110, 111 are glued into the mechanical support in one embodiment. However, these could be press-fitted or attached in another manner to the mechanical support. The top surfaces of each magnet extend above the top of the mechanical support, thereby forming a magnetic surface. Once the magnets are attached to the module, the module is lowered toward the cavity using the tab handle. When the module reaches a point of magnetic attraction, the magnets such as 111 act on the ferromagnetic material such as 140 and pull the module into location with the face of the mechanical support.

Either one of the magnet or ferromagnetic material can be used for alignment between the module and the support, according to embodiments.

The module is constrained in the plane of the interfering surface by having the ferromagnetic material mating concentrically with the hole in the mechanical support thus locating the module in the plane.

Installation/removal is accomplished by means of an adhesive tab handle 151 on an adhesive tab assembly 150. The tab on this handle can be flipped down so as not to stick up when not installing or removing the module, this minimizing the distance that exists between the top of the module and the back of the collimator of the gamma camera into which the device is configured.

The magnetic fastening of the module solves/addresses several problems of attachment of a tileable (4-side buttable) detector module where there is limited or no access to the sides of the module, and where a desire for full active area requirement precludes fasteners entering the module through the imaging plane.

Additionally the magnetic attachment offers a number of benefits in this application. First, the force applied is limited to the magnetic strength of the magnet together with the susceptibility of the ferromagnetic fastener element. In one embodiment, this case is positioned on the module. In another embodiment, however, the magnet is on the module and the housing is magnetic. By limiting the force to the magnetic strength, this has the advantage of preventing mechanical damage to the module which could otherwise occur when typical fasteners pull when the module would be pushed/pulled/torqued down with a mechanical fastener. Moreover, the amount of force is very repeatable, and hence can be more accurately predicted.

In one embodiment, the pressure from the magnetic attraction may be applied to hold the detector module against the mechanical registration point, in order to thermally conduct heat away from the module. The magnetic coupling insures that a fixed amount of force is applied at the interface without user intervention. A mechanical fastener would otherwise become difficult to use because there is a double constraint of pulling the module to the interfering cooling face; however not pulling that so hard as to damage the module.

The same operation could conceivably be done with springs or other fasteners from the backside; however it would be difficult to do this with this positive force from the front side, since this would have to be done blind via a mechanical attachment.

Accurate registration can be maintained with this attachment method by designing the registration components, such as the concentric portion, into the interfering parts without the burden of having the fastening element causing misalignment. For example, torqueing a screw or using a snap tends to apply a lateral force fighting against registration.

Large assemblies of tileable modules can require the accurate fastening of many screws or other fasteners. The magnetic coupling is faster than attaching the screws.

In this application, continuous radiation shielding is used where there can be no holes in the shields/or holes need to be covered. This adds to the complexity of the shielding solution and or mechanical design to allow for holes in the shield for the fastener interface.

Another solution can attach the modules to a first object, and then attaches of this first object on its edges/sides to the mechanical/thermal registration point. A disadvantage of this solution is that it requires extra fasteners (in addition to those used by the module), and most likely the addition of deadspace or an occluded fastener on the fastening edges when tiling, thereby making it suboptimal from a tiling point of view.

Removal/installation of the module can be accomplished using an adhesive tab handle that is attached to the module before it is installed into the mechanical support, and can remain attached once installed due to its high radiotransparency. The module attenuates high energy photons very little. This thin adhesive tab enables tight “butting” of the module due to its small thickness In an embodiment, this can be <0.003 in, and could be made thinner.

The above has described only a single module being placed into the support 120. However, another module can also be placed into the support, butted directly against the shown module 100. Any number of modules can be connected to one another in this way. Moreover, the mechanical support is shown as having different tray areas such as 127, between the side parts 125, 126 where each tray area holds a specific module. Any of the tray areas as shown in FIG. 1 can hold a module, such that a number of modules can be held against one another.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, the above has described a specific system, but other systems can be used. For example, other materials can be used.

What is claimed is:

1. A method, comprising:
using a first module which has multiple sides that can butt against another module other than said first module and where said first module is configured such that the first module can butt directly up against the another module; and
magnetically holding the first module in place against a support.

2. A method as in claim 1, wherein said module is a multi-sided buttable medical imaging module.

3. A method as in claim 1, further comprising attaching a ferromagnetic material to said module, and wherein said magnetically holding comprises using said ferromagnetic material to magnetically attract to a magnet.

4. A method as in claim 3, further comprising connecting said magnet to the mechanical support.

5. A method as in claim 4, wherein said magnet is glued to said mechanical support.

6. A method as in claim 4, wherein said magnet has an outside contour that is held within a contoured surface within said mechanical support.

7. A method as in claim 6, wherein said magnet is substantially round in outer shape, and said contoured surface within said mechanical support is round.

8. A method as in claim 4, wherein said mechanical support has plural different surfaces for holding said modules.

9. A method as in claim 1, further comprising holding the another module against the support, and directly butting against said first module.

10. A method as in claim 1, further comprising using a tab handle to attach to said module, and to place said module in place, wherein said tab handle is sufficiently thin so as to not block high energy photons.

11. An apparatus, comprising:
a first multisided, buttable module, which has multiple sides that can each butt directly against another module such that the first module can butt directly up against the another module; and
a magnetic attachment part, magnetically holding the first module in place against a support.

12. An apparatus as in claim 11, wherein said magnetic attachment part comprises a ferromagnetic material attached to said module, and further comprising a magnet which magnetically attracts to said ferromagnetic material.

13. An apparatus as in claim 11, wherein said magnetic attachment part comprises a magnet attached to a support, and further comprising a ferromagnetic material on said module which magnetically attracts to said magnet.

14. An apparatus as in claim 11, further comprising the mechanical support which attracts against said magnetic attachment part.

15. An apparatus as in claim 14, wherein said mechanical support includes a contoured surface which holds a magnet that attracts said magnetic attachment part, and wherein said magnet has a surface that matches said contoured surface to be held within said contoured surface.

16. An apparatus as in claim 15, wherein said magnet is substantially round in outer shape, and said contoured surface within said mechanical support is round.

17. An apparatus as in claim 15, wherein said mechanical support has plural different contoured surfaces for aligning multiple of said modules.

18. An apparatus as in claim 17, further comprising holding another multisided buttable module against the support, and directly butting against said first module.

19. An apparatus as in claim 11, further comprising using a tab handle to attached to said module, and to place said module in place, wherein said tab handle is sufficiently thin so as to not block high energy photons.
